(19) United States
(12) Patent Application Publication
(10) Pub. No.: US 2022/0374984 A1
(43) Pub. Date: Nov. 24, 2022

(54) FOREIGN EXCHANGE MARGIN TRADING SUPPORT PROGRAM, RECORDING MEDIUM HAVING THE SAME STORED THEREON, AND FOREIGN EXCHANGE MARGIN TRADING SUPPORT SYSTEM

(71) Applicant: ALAT'Z CO., LTD, Tokyo (JP)

(72) Inventor: Teruyuki OKAMOTO, Tokyo (JP)

(21) Appl. No.: 17/769,856

(22) PCT Filed: Dec. 15, 2020
(86) PCT No.: PCT/JP2020/046627

§ 371 Date: Apr. 18, 2022

(30) Foreign Application Priority Data
Feb. 6, 2020 (JP) 2020-018452

(51) Int. Cl. G06Q 40/04; G06T 11/20

(52) U.S. Cl. CPC G06Q 40/04; G06T 11/203

(57) ABSTRACT

The present invention arbitrarily draws one or more lines on the same chart of a terminal device of an investor who conducts foreign exchange margin trading, selects any order type, and automatically perform an action of the selected order type. Solution: There are provided a program for indicators that allows the investor's terminal device to function as line setting means for drawing a line, line information acquisition means, transaction attribute output means, and transaction attribute output means, and a program for expert advisors that allows the investor's terminal device to function as order information output means and order placing means.

### TECHNICAL FIELD

The present invention relates to a foreign exchange margin trading support program for displaying, on a terminal device of an investor, who conducts foreign exchange margin transactions (also known as foreign exchange; hereinafter abbreviated to “FX”), various kinds of indices based on market data acquired from an FX company via the Internet and allowing the investor to automatically place an entry order or an exit order with the FX company at any timing specified by the investor, in cooperation with trading software for placing a buy/sell order with the FX company (i.e., MetaTrader, hereinafter abbreviated to “MT4”), a recording medium having the same stored thereon, and a foreign exchange margin trading support system including the same.

### BACKGROUND ART

Many FX companies have heretofore employed the MT4 as a transaction platform.

The standard equipment of the MT4 includes a function of displaying foreign exchange rates streamed from a FX company with charts on a screen and general functions from an indicator function of graphically displaying values calculated from the foreign exchange rates on the charts, an expert advisor function of automatically repeating transactions at any timing according to a preset transaction strategy (hereinafter abbreviated to “EA”), and a script function of undergoing a process defined by rules only once. For those functions, any original program created by a trader, a software house, or the like can be installed on the platform.

In view of the above, the prior art discloses a program for market analysis that supports an investor with a function of determining a turning point of a trend from a historical behavior of a chart, calculating a target value for rise or fall from a reference value separated from the steadiness, a price range from the reference value, the number of bars exceeding the reference value, and the number of vertical variations to the turning point, and displaying the target value on the chart (see Patent Literature 1).

Thus, the indicator function can display a calculation result if a calculation rule has been registered, but cannot have a transaction function.

In contrast, once a transaction rule or an order detail for any transaction has been set, the expert advisor function can automatically conduct a transaction in accordance with the rule and the order detail. However, even if a trend of a foreign exchange rate changes, the expert advisor function cannot change the transaction rule so as to correspond to the trend change. The script function enables a manual transaction but cannot implement an automatic transaction.

Therefore, techniques used by traders who have vast knowledge and experience and stably earn a huge profit may be copied for other general investors to conduct transactions.

However, many investors hesitate to entrust transactions entirely with other investors. Thus, the prior art discloses a foreign exchange margin trading support system that displays, on a terminal of a general investor, reproduced information on charts or indicators displayed on terminals of those experienced traders and allows the general investor to conduct a transaction with reference to the reproduced information (see Patent Literature 2).

### PRIOR ART LITERATURE

### Patent Literature

JP 2019-207452 A
WO 2015/075824

### SUMMARY OF THE INVENTION

### Problem(s) to be Solved by the Invention

However, a transaction method of conducting transactions while copying another person's technique binds an investor for a certain period of time. Therefore, investors who do not have sufficient time may conduct automatic transactions with use of EAs developed by others. Investors who well understand various functions of the MT4 and transaction methods using the MT4 often conduct transactions at their discretion.

Meanwhile, any EA developed by another is bound by transaction logic of the developer. Thus, the EA cannot change a transaction rule when a trend of a foreign exchange rate changes. Therefore, a transaction may be conducted at inappropriate timing, resulting in increased loss. Furthermore, a trader may leave a terminal device on which charts are displayed during discretionary transactions. In such a case, the charts may unexpectedly change to a large extent, resulting in loss of exit timing.

In view of the above, the applicant has developed a program (product name “ProEX” (https://fxmt.co/transmission/)) to draw a trend line in advance on a chart with indicators and place an exit order automatically when the chart touches the line.

However, only one action can be performed automatically in the same chart. Therefore, a plurality of charts need to be prepared to place a plurality of entry orders or a plurality of exit orders.

The present invention has been made in view of the above. It is an object of the present invention to provide a program for arbitrarily drawing one or more horizontal/oblique lines on the same chart of an MT4 downloaded to a terminal device based on one's own strategy, selecting any order type, and automatically performing an action of the selected order type when the chart touches the lines, and a recording medium having such a program recorded thereon, and a foreign exchange margin trading support system having a terminal device to which the program has been loaded for automatically placing an entry order or an exit order.

### Means for Solving Problem(s)

The present invention is provided as a foreign exchange margin trading support program for automatically placing an entry order or an exit order at timing specified by an investor who conducts foreign exchange margin trading, the foreign exchange margin trading support program comprising: a program for an indicator that allows an investor's terminal device, in which a foreign exchange rate streamed from an FX company is displayed in a form of a chart on a screen with a platform downloaded from a server of the FX company via the Internet, to function as: line setting means for drawing a straight line connecting a start point and an end point specified with a cursor on the screen, line information storage means for associating identification information with the line drawn by the line setting means, calculating respective time values from a straight line equation for the line, and storing the calculated time value for each piece of the identification information, transaction attribute selection means for displaying an attribute list representing types of the transactions when a predetermined area of the line is manipulated with the cursor, displaying a selected attribute on the area when any attribute is selected from the list, and storing the attribute in association with the identification information stored in the line information storage means, and transaction attribute output means for comparing the value stored in the line information storage means to the foreign exchange rate and reading and outputting, from the transaction attribute selection means, the attribute associated with the identification information of the line for which the value has been calculated when the value is within a predetermined range from the foreign exchange rate; and a program for an expert advisor that allows the investor's terminal device to function as: order information output means for outputting order information in which a predetermined parameter stored in parameter storage means is added to the attribute when the attribute outputted from the transaction attribute output means is detected, and order placing means for executing the order information outputted from the order information output means, displaying a conducted transaction result on the screen, and storing the conducted transaction result in storage means.

Thus, if an investor draws one or more horizontal/oblique lines on a chart of a screen of an MT4 provided as a platform by an FX company and selects any order type for each of the lines based on his/her own strategy, then an action of the selected order type is automatically performed when the chart touches any of those lines. Therefore, the investor can conduct FX transactions without being temporally bound.

Furthermore, the transaction attribute selection means is operable to display, at a side of the area in which the attribute is displayed, an ON/OFF button for allowing selection of activation or inactivation of the attribute with operation of the cursor. The displayed attribute list may include a buy order, a sell order, an order change, an exit order for a buy order, an exit order for a sell order, and an exit order for all transactions.

The line can freely be moved or deleted with operation of the cursor. The transaction attribute selection means is operable to move a display position of the list and a display area of the attribute when the line is moved and to delete the list and the attribute when the line is deleted.

Therefore, a plurality of lines can be drawn on the same chart screen, and different types of transactions can be designated for each of the lines. Trend lines can be moved. Accordingly, even if the chart changes differently than expected, it is possible to reduce loss and automatically place a plurality of orders on the same chart depending on the market change.

The program for indicators is operable to set a parameter as conditions for retrieving the rate streamed from the FX company to the transaction attribute output means when the indicator is dragged and dropped into the screen displaying the chart to activate. The program for expert advisors is operable to set the parameter when the expert advisor is dragged and dropped into the screen displaying the chart to activate. Thus, the programs can be customized for preference.

The action performance means is operable to conduct a transaction in accordance with the parameter included in the order information if the attribute of the order information is a buy order or a sell order, conduct a transaction to settle an oldest unsettled buy order if the attribute is an exit order for a buy order, conduct a transaction to settle an oldest unsettled sell order if the attribute is an exit order for a sell order, and conduct a transaction to settle all unsettled buy and sell orders if the attribute is an exit order for all transactions. When a transaction result is displayed on the screen by the action performance means, the transaction attribute selection means can delete the corresponding attribute while the line setting means can delete the corresponding line.

The program for indicators, the program for expert advisors, and a foreign exchange margin trading support program may be provided as being recorded on a computer-readable recording medium or provided in a digital data format via the Internet or the like.

A foreign exchange margin trading support system according to the present invention is for downloading a platform from a server of an FX company via the Internet to an investor's terminal device for conducting foreign exchange margin trading, displaying a foreign exchange rate streamed from the FX company in a form of a chart, and automatically placing an entry order or an exit order at timing specified by the investor, wherein the investor's terminal device comprises: line setting means for drawing a straight line connecting a start point and an end point specified with a cursor on the screen in the form of the chart, line information storage means for associating identification information with the line drawn by the line setting means, calculating respective time values from a straight line equation for the line, and storing the calculated time value for each piece of the identification information, transaction attribute selection means for displaying an attribute list representing types of the transactions when a predetermined area of the line is manipulated with the cursor, displaying a selected attribute on the area when any attribute is selected from the list, and storing the attribute in association with the identification information stored in the line information storage means, transaction attribute output means for comparing the value stored in the line information storage means to the foreign exchange rate and reading and outputting, from the transaction attribute selection means, the attribute associated with the identification information of the line for which the value has been calculated when the value is within a predetermined range from the foreign exchange rate, order information output means for outputting order information in which a predetermined parameter stored in parameter storage means is added to the attribute when the attribute outputted from the transaction attribute output means is detected, and order placing means for executing the order information outputted from the order information output means, displaying a conducted transaction result on the screen, and storing the conducted transaction result in storage means.

Thus, the foreign exchange margin trading support system includes an investor's terminal to which the aforementioned foreign exchange margin trading support program has been incorporated. Therefore, the foreign exchange margin trading support system can automatically place an entry order or an exit order at any timing specified by the investor.

### Advantageous Effects of the Invention

With a foreign exchange margin trading support system according to the present invention to which an investor's terminal device having a foreign exchange margin trading support program according to the present invention has been incorporated, when an investor conducts an FX transaction using an MT4 as a platform, the investor can draw any trend line on a chart screen. If a type of transactions, including an entry order and an exit order, is specified, a transaction is automatically conducted when the chart changing over time touches the line. Accordingly, temporal restrictions for trading can be eliminated. Furthermore, a plurality of lines can be drawn on the same chart screen, and different types of transactions can be designated for each of the lines. Trend lines can be moved. Accordingly, even if the chart changes differently than expected, it is possible to reduce loss and automatically place a plurality of orders specified depending on the market change based on one's own strategy.

### BRIEF DESCRIPTION OF DRAWINGS

FIG. 1 is a diagram showing a configuration of a foreign exchange margin trading support system according to an embodiment of the present invention.

FIG. 2 is a diagram showing a screen layout displayed upon initialization of an MT4.

FIG. 3 is a functional block diagram showing functions of a foreign exchange margin trading support program according to an embodiment of the present invention.

FIG. 4 is a diagram showing an example in which a line has been drawn with transaction attributes displayed.

FIG. 5 is a diagram showing another example in which lines have been drawn with transaction attributes displayed.

FIG. 6 is a diagram showing still another example in which lines have been drawn with transaction attributes displayed.

FIG. 7 is a diagram showing an example of a process flow to conduct transactions with an action performance means.

### MODE(S) FOR CARRYING OUT THE INVENTION

Embodiments of a foreign exchange margin trading support system according to the present invention, which includes components of a foreign exchange margin trading support program according to the present invention and an investor's terminal device on which the program has been installed, will be described below with reference to the drawings.

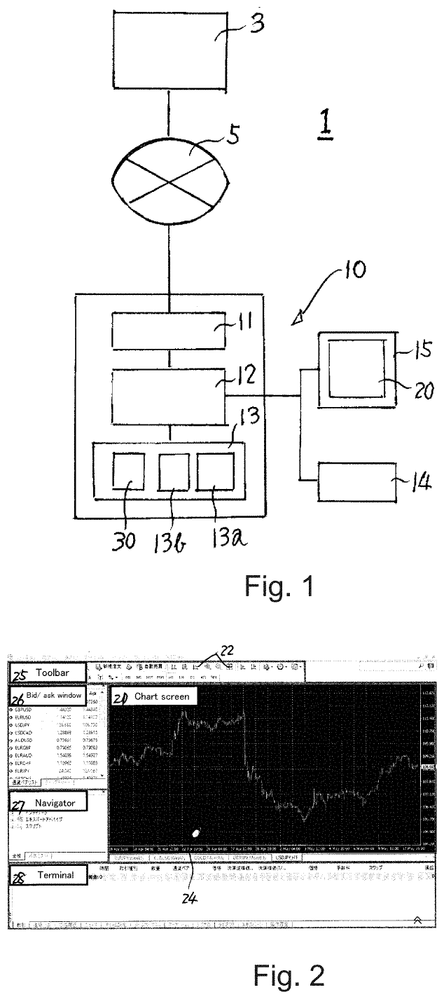

FIG. 1 is a diagram showing a configuration of a foreign exchange margin trading support system according to an embodiment of the present invention.

A foreign exchange margin trading support system 1 of the present embodiment as illustrated in FIG. 1 includes a server 3 of an FX company and an investor's terminal device 10, which are connected to each other via the Internet 5. A foreign exchange margin trading support program 30 of the present embodiment has been provided on the investor's terminal device 10.

The investor's terminal device 10 may comprise a personal computer (hereinafter abbreviated to “PC”), an I-PAD, or a smart phone. The investor's terminal device 10 has a communication unit 11 connected to the Internet 5, a controller 12, a memory unit 13, an input unit 14, and an output unit 15. The output unit 15 has a screen 20 such as a liquid crystal display, on which charts, lines, and the like are displayed. The input unit 14 may comprise a keyboard or a mouse and can manipulate a cursor 24 displayed on the screen 20.

With use of a platform 13a downloaded to the investor's terminal device 10 from the server 1, a foreign exchange rate streamed from the FX company is displayed in the form of a chart on the screen 20. The installed foreign exchange margin trading support program 30 is executed to automatically place an entry order or an exit order at any timing specified by the investor.

The foreign exchange margin trading support program 30 recorded on a recording medium such as a CD may be uploaded to the investor's terminal device 10. Alternatively, the foreign exchange margin trading support program 30 may be downloaded online to the investor's terminal device 10.

The memory unit 13 is formed by a hard disk or a flash memory that stores the platform 13a such as the MT4, which is downloaded from the server 1 of the FX company, files 13b including streamed foreign exchange rates, the foreign exchange margin trading support program 30, parameters, and the like.

The controller 12 is operable to control the communication unit 11, the input unit 14, the output unit 15, and the memory unit 13, read and execute the platform 13a, the foreign exchange margin trading support program 30, and the like, and display the execution results on the output unit 15.

FIG. 2 is a diagram showing a screen layout displayed upon initialization of the MT4.

As shown in FIG. 2, a toolbar 25, which includes items that can be set with one button, is displayed at the top of the screen 20. A bid/ask window 26, which includes bid/ask prices for respective currency pairs, and a navigator window 27, which includes an account number for the FX company, indicators, expert advisors, and scripts, are displayed on the left side of the screen.

A window 20, which includes a chart, is displayed on the right side of the screen. Upon initialization, four windows 20, each of which includes a graph of variations of a foreign exchange rate of a selected currency pair, are displayed.

A terminal window 28 is displayed on the bottom of the screen 20. The terminal window 28 includes a status of transactions, an account history, an operation history, and the like.

The size and layout of those windows can be customized by a user. The displayed chart can be customized by using icons displayed on the toolbar 25. The type of the chart can be selected from among three types of the “candlestick chart,” the “bar chart,” and the “line chart.” The time axis for displaying the chart can be selected from among a one-minute chart (with one-minute bars), a five-minute chart (with five-minute bars), a 30-minute chart (with 30-minute bars), a hourly chart (with one-hour bars), a four-hour chart (with four-hour bars), a daily chart (with one-day bars), a weekly chart (with one-week bars), and a monthly chart (with one-month bars).

Furthermore, the navigator window 27 includes, as standard functions, programs for conducting technical analysis of charts, which are called indicators, and programs for conducting automatic transactions with various logics, which are called Expert Advisors (hereinafter abbreviated to “EA”). Those functions can be customized by newly developed programs.

Indicators may be displayed additionally on the screen 20 displaying a chart, displayed separately from a chart on another window below the screen 20 displaying the chart, displayed with varying colors in a chart, or the like.

Specifically, there has been known a moving average line MA produced by averaging closing prices of a foreign exchange rate over a predetermined period of time and connecting those averaged prices. The moving average line tells us a trend or a strength of a foreign exchange rate.

There also has been known a Bollinger Band that estimates a range of a price fluctuation by adding a standard deviation above and below a moving average line. The Bollinger Band tells us when a current price is excessively deviated from the moving average line.

The EAs can run on the platform 13a, which is trading software. The EAs are programs for automatically instructing the FX company on transactions.

A desired one of the indicators and the EAs displayed on the navigator window 27 is dragged and dropped on the screen 20 in which the chart is displayed and then activated after setting parameters, specifying colors, and the like.

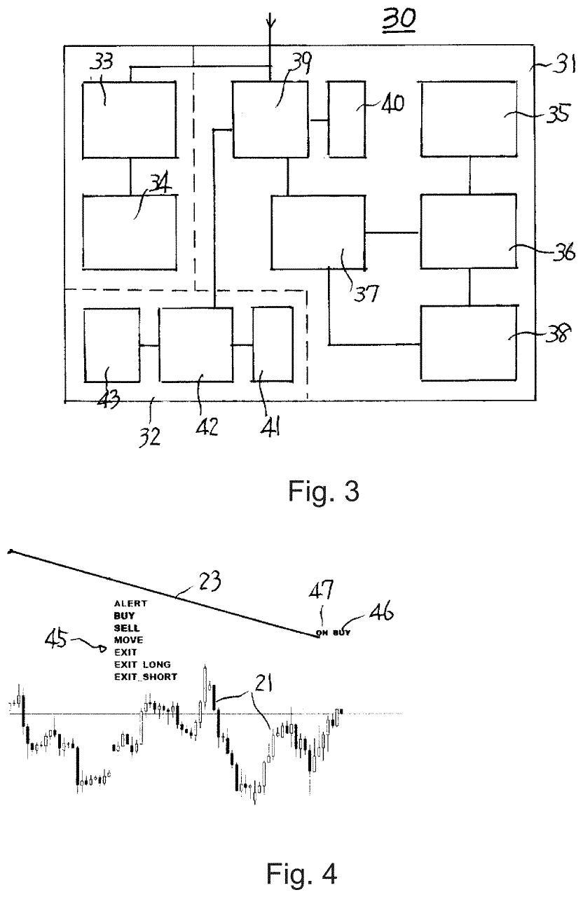

FIG. 3 is a functional block diagram showing functions of a foreign exchange margin trading support program according to an embodiment of the present invention.

The foreign exchange margin trading support program 30 of the present embodiment as illustrated in FIG. 3 includes a program 31 for indicators and a program 32 for expert advisors, which are to be installed on the platform (MT4) 13a downloaded to the investor's terminal device 10 from the server 1 of the FX company via the Internet 5, and programs for allowing the investor's terminal device 10 to function as a foreign exchange rate storage means 33 for storing foreign exchange rates streamed from the FX company and the like and a chart display means 34 for displaying one or more charts on the screen 20.

Those programs are used to achieve a function of automatically placing an entry order or an exit order at timing specified by the investor in the foreign exchange margin trading support system including the server 3 of the FX company that is connected via the Internet 5 and the investor's terminal device 10.

For example, the foreign exchange rate storage means 33 comprises a CSV file in which a closing price, an opening price, a high price, and a low price of each of time bars for respective foreign exchange rates have been recorded.

The chart display means 34 is operable to display the rates recorded in the CSV file with use of candlestick bars each having shadows, a real body, and a color, a bar chart using vertical bars and horizontal bars, or a line chart in which the closing prices are connected by lines.

The program 31 for indicators has a line setting means 35, a line information acquisition means 36, a line information storage means 37, a transaction attribute selection means 38, a transaction attribute output means 39, and a condition parameter storage means 40. The program 32 for expert advisors has a transaction parameter storage means 41, an order information output means 42, and an action performance means 43.

The line setting means 35 is a tool for drawing a straight line 23 connecting a start point and an end point to each other when the start point and the end point are specified in the screen 20 displaying the chart by clicking and moving the cursor 24 displayed on the screen 20.

In the present embodiment, after a trend icon is clicked in the toolbar 25 displayed at the top of the screen 20 illustrated in FIG. 2 by the cursor 24, a start point is defined when any point is clicked in the screen 20 displaying the chart 21 by the cursor 24. A line 22 is drawn while the cursor 24 is moved in a clicked state. An end point is defined when the moving and clicking action of the cursor 24 is quitted. The line 22 drawn with this tool can be deleted when a transaction result is displayed on the screen 20 by the action performance means 43 of the program 32 for expert advisors as described below.

The line information acquisition means 36 is operable to calculate positional information of the start point and the end point of the line 22 drawn by the line setting means 35 and an equation of the straight line connecting the start point and the end point and to specify an identification number for that line. The line information acquisition means 36 is further operable to calculate time values of the start point and the end point in a unit of time in which the chart 21 is displayed.

The line information storage means 37 is operable to store the respective time values calculated by the line information acquisition means 36 for each of the identification numbers of the lines 22.

As illustrated in FIG. 2, various icons are displayed in the toolbar 25 at the top of the MT4 screen 20.

For example, by clicking the indicator icons, the investor can display a moving average line MA of an implemented foreign exchange rate or display a Bollinger Band BB to analyze the price fluctuation in the market. Then the investor can determine whether there is any trend or boxed range in the market and predict a future behavior of the market with the line 22 drawn by the line setting means 35.

The transaction attribute selection means 38 is operable to display any transaction attribute 46 near the end point of the line 22 (“a predetermined area for the line” according to the present invention) when the line 22 is drawn by the line setting means 35 and also display an ON/OFF button 47, which allows the investor to selectively activate or inactivate the transaction attribute 46, at a side of the transaction attribute 46 (see FIGS. 4(1) to 4(3)).

When the investor clicks the displayed transaction attribute 46 with the cursor 24, the transaction attribute selection means 38 is operable to display, near the line 23, a transaction attribute list 45 including transaction attributes to be executed when the chart 21 that meets the conditions set with parameters touches, breaks out above, or breaks out below the line 23.

In the present embodiment, the displayed transaction attribute list 45 includes a buy order (BUY), a sell order (SELL), an order change (MOVE), an exit order for a buy order (EXIT LONG), an exit order for a sell order (EXIT SHORT), and an exit order for all orders (EXIT). The displayed transaction attribute list 45 is not necessarily be limited to this example.

When the investor selects a desired transaction attribute 46 from the transaction attribute list 45 by clicking the desired transaction attribute 46 with the cursor 24, the transaction attribute 46 displayed near the end point of the line 23 is changed to the selected transaction attribute 46. The selected transaction attribute 46 is stored in the line information storage means 37 in association with the identification number of the line 23.

When the ON/OFF button 47 displayed at the side of the transaction attribute 46 is clicked with the cursor 24, ON is switched to OFF, and OFF is switched to ON.

The displayed transaction attribute 46 and the ON/OFF button 47 can be deleted when a transaction result is displayed on the screen 20 by the action performance means 43 of the program 32 for expert advisors as described below.

The condition parameter storage means 40 is operable to store parameter conditions set by the investor that are used to determine whether the chart touches the line 23.

For example, such conditions may be defined by the time when a real body of a candlestick bar or a bar chart that represents an opening price and a closing price touches the line 23, or the time when a shadow representing a high price or a low price touches the line 23. Furthermore, the conditions may be defined by the time when a plurality of consecutive candlestick bars touch the line 23.

The conditions for touch may be defined by the time when the chart breaks out above or below the line or by the time when a deviation from the line is within a predetermined range.

The transaction attribute output means 39 is operable to access the line information storage means 37 that stores values for each of the lines 23 when it receives a foreign exchange rate streamed from the FX company. When the values at that time are within 0.5% or less (“within a predetermined range” according to the present invention) from the received rate, the transaction attribute output means 39 is operable to read and output an identification number of the line 23 for which the values have been calculated and a transaction attribute 46 associated with the identification number.

In the present embodiment, the predetermined range within which the rate can be deviated from the line is set to 0.5%. This range is not necessarily limited to 0.5% or less and may be 0.1% or less, or 1% or less.

The program 32 for expert advisors has a transaction parameter storage means 41, an order information output means 42, and an action performance means 43.

According to the MT4, when the program 32 for expert advisors is dragged and dropped to the screen 20 displaying the chart 21 to be activated, a window for setting parameters is automatically displayed. Thus, the investor can set any values for those parameters.

The transaction parameter storage means 41 is operable to store parameters set by the investor, such as a transaction size, a stop-loss price, a limit price, an allowable slippage, a magic number, and a time slot during which actions are permissible.

When the transaction attribute 46 outputted from the transaction attribute output means 39 is detected, the order information output means 42 is operable to add a predetermined parameter stored in the transaction parameter storage means 40 to the detected transaction attribute 46 to output order information. For example, if the transaction attribute 46 is a buy order, the order information output means 42 adds a transaction size, a stop-loss price, a limit price, an allowable slippage, and the like to the transaction attribute 46.

The order placing means 43 is operable to place an order to the FX company based on the order information outputted from the order information output means 42.

If the transaction attribute 46 of the order information is a buy order (BUY) or a sell order (SELL), a transaction is conducted in accordance with parameters included in the order information.

If the transaction attribute 46 is an exit order for a buy order (EXIT LONG), an exit order is placed for a buy order (BUY) that was completed earliest in pending transactions. If the transaction attribute 46 is an exit order for a sell order (EXIT SHORT), an exit order is placed for a sell order (SELL) that was completed earliest in pending transactions.

If the transaction attribute is an exit order for all orders (EXIT), an exit order is placed for all of buy and sell orders (BUY and SELL) in pending transactions.

If any of a buy order and a sell order (BUY and SELL), exit orders (EXIT LONG, EXIT SHORT, and EXIT) is completed, the completed transaction result is displayed on the screen 20 and stored in the storage means.

FIGS. 4 to 6 are diagrams showing examples having one or more lines drawn and transaction attributes displayed.

In an example illustrated FIG. 4, a line 23 is drawn on the chart 21 displayed on the screen 20. Any transaction attribute 46 is displayed near an end point of the line 23. FIG. 4 shows a state in which a transaction attribute list 45 is displayed when the transaction attribute 46 is clicked by a cursor 24.

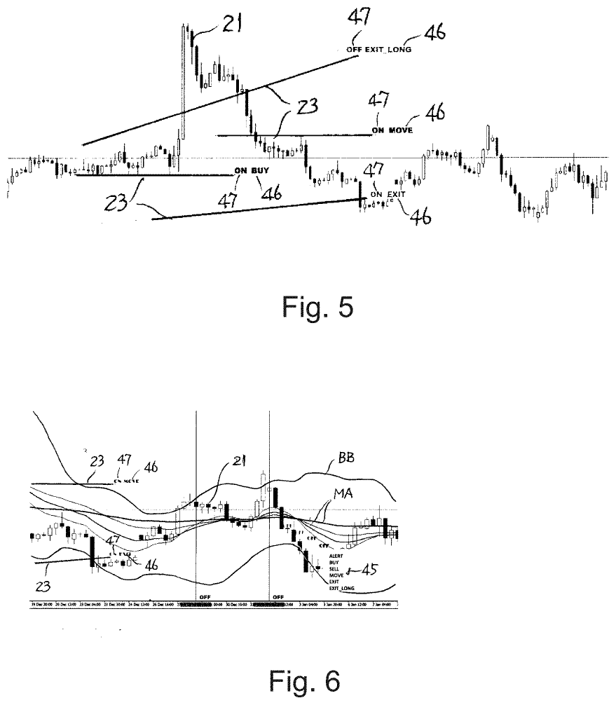

In another example illustrated in FIG. 5, four lines 23 are drawn on the chart 21. An transaction attribute 46 is displayed near an end point of each of the lines 23.

FIG. 5 shows the following situation. At a lower side of the screen, a line 23 for a buy order (ON BUY) was drawn along a support line, and a line 23 for an exit order for a buy order (EXIT LONG) was drawn above the line 23 for a buy order. However, the price rapidly rose before the buy order was completed and then dropped. Thus, a line for a change order (ON MOVE) was drawn near a resistance line. Contrary to expectations, however, the chart 21 fell. Therefore, the order for a buy order (EXIT LONG) was cancelled (OFF EXIT LONG), and a line for an exit order for loss cut (ON EXIT) was newly drawn below the line 23 for the initial buy order (ON BUY).

In still another example illustrated in FIG. 6, four moving average lines MAs, a Bollinger Band BB, and two lines 23 were drawn on the chart 21 with a transaction attribute list 45 displayed.

An upper line 23 for change of transaction attributes 46 (ON MOVE) and a lower line 23 for an exit order (ON EXIT) were drawn as lines 23 representing the trend.

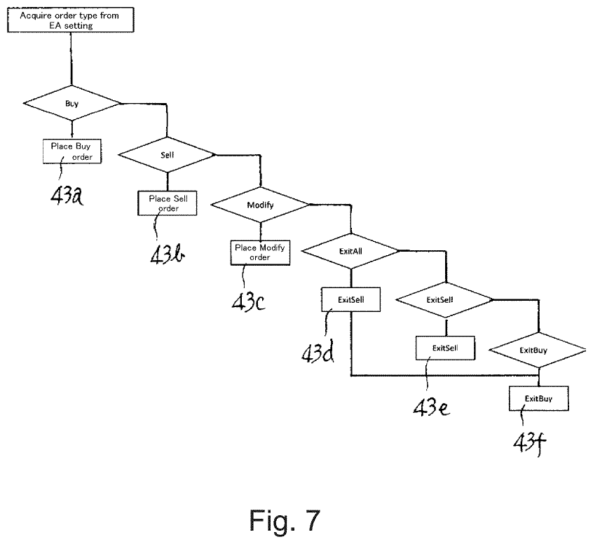

FIG. 7 is a diagram showing an example of a process flow to conduct transactions with the action performance means.

As shown in FIG. 7, the order placing means 43 acquires a transaction attribute 46 from order information outputted from the order information output means.

The order placing means 43 determines whether or not the transaction attribute 46 is BUY. If the transaction attribute 46 is BUY, the order placing means 43 places a BUY order to the FX company according to the set parameters (step 1) 43a.

If the transaction attribute 46 is not BUY, the order placing means 43 determines whether or not the transaction attribute 46 is SELL. If the transaction attribute 46 is SELL, the order placing means 43 places a SELL order to the FX company according to the set parameters (step 2) 43b.

If the transaction attribute 46 is not SELL, the order placing means 43 determines whether or not the transaction attribute 46 is MODIFY. If the transaction attribute 46 is MODIFY, the order placing means 43 changes the type of the order being processed or the like and places a change order to the FX company (step 3) 43c.

If the transaction attribute 46 is not MODIFY, the order placing means 43 determines whether or not the transaction attribute 46 is EXIT ALL. If the transaction attribute 46 is EXIT ALL, the order placing means 43 places an exit order for any unsettled sell orders to the FX company (step 4) 43d and simultaneously places an exit order for any unsettled buy orders to the FX company (step 4) 43f.

If the transaction attribute 46 is not EXIT ALL, the order placing means 43 determines whether or not the transaction attribute 46 is EXIT SELL. If the transaction attribute 46 is EXIT SELL, the order placing means 43 places an exit order for any unsettled sell orders to the FX company (step 5) 43e.

If the transaction attribute 46 is not EXIT SELL, the order placing means 43 determines whether or not the transaction attribute 46 is EXIT BUY. If the transaction attribute 46 is EXIT BUY, the order placing means 43 places an exit order for any unsettled buy orders to the FX company (step 6) 43f.

### INDUSTRIAL APPLICABILITY

The present invention can provide an opportunity for investment in FX transactions to those who do not have sufficient time. Furthermore, the present invention can provide an opportunity of studying FX transactions to beginners at FX transactions.

### DESCRIPTION OF REFERENCE NUMERALS AND SIGNS

1 Foreign exchange margin trading support system
3 Server
5 Internet
10 Investor's terminal device
11 Communication unit
12 Controller
13 Memory unit
13a Platform
13b File
14 Input unit
15 Output unit
20 Screen
21 Chart
22 Icon
23 Line
24 Cursor
25 Toolbar
26 Bid/ask window
27 Navigator window
28 Terminal window
30 Foreign exchange margin trading support program
31 Program for indicators
32 Program for expert advisors
33 foreign exchange rate storage means
34 Chart display means
35 Line setting means
36 Line information acquisition means
37 Line information storage means
38 Transaction attribute selection means
39 Transaction attribute output means
40 Condition parameter storage means
41 Transaction parameter storage means
42 Order information output means
43 Order placing means
45 Transaction attribute list
46 Transaction attribute
47 ON/OFF button

1: A non-transitory computer-readable storage medium storing a foreign exchange margin trading support program for causing a computer to automatically place an entry order or an exit order at timing specified by an investor who conducts foreign exchange margin trading, the foreign exchange margin trading support program comprising:
a program for an indicator that allows an investor's terminal device, in which a foreign exchange rate streamed from an FX company is displayed in a form of a chart on a screen with a platform downloaded from a server of the FX company via the Internet, to function as:
line setting means for drawing a straight line connecting a start point and an end point specified with a cursor on the screen,
line information storage means for associating identification information with the line drawn by the line setting means, calculating respective time values from a straight line equation for the line, and storing the calculated time value for each piece of the identification information,
transaction attribute selection means for displaying an attribute list representing types of the transactions when a predetermined area of the line is manipulated with the cursor, displaying a selected attribute on the area when any attribute is selected from the list, and storing the attribute in association with the identification information stored in the line information storage means, and
transaction attribute output means for comparing the value stored in the line information storage means to the foreign exchange rate and reading and outputting, from the transaction attribute selection means, the attribute associated with the identification information of the line for which the value has been calculated when the value is within a predetermined range from the foreign exchange rate; and
a program for an expert advisor that allows the investor's terminal device to function as:
order information output means for outputting order information in which a predetermined parameter stored in parameter storage means is added to the attribute when the attribute outputted from the transaction attribute output means is detected, and
order placing means for executing the order information outputted from the order information output means, displaying a conducted transaction result on the screen, and storing the conducted transaction result in storage means.

2: The non-transitory computer-readable storage medium as recited in claim 1, wherein the transaction attribute selection means is operable to display, at a side of the area in which the attribute is displayed, an ON/OFF button for allowing selection of activation or inactivation of the attribute with operation of the cursor.

3: The non-transitory computer-readable storage medium as recited in claim 1, wherein the attribute list displayed by the transaction attribute selection means includes a buy order, a sell order, an order change, an exit order for a buy order, an exit order for a sell order, and an exit order for all transactions.

4: The non-transitory computer-readable storage medium as recited in claim 1, wherein the line can freely be moved or deleted with operation of the cursor, and
the transaction attribute selection means is operable to move a display position of the list and a display area of the attribute when the line is moved and to delete the list and the attribute when the line is deleted.

5: The non-transitory computer-readable storage medium as recited in claim 3, wherein the order placing means is operable to
conduct a transaction in accordance with the parameter included in the order information if the attribute of the order information is a buy order or a sell order,
conduct a transaction to settle an oldest unsettled buy order if the attribute is an exit order for a buy order, conduct a transaction to settle an oldest unsettled sell order if the attribute is an exit order for a sell order, and conduct a transaction to settle all unsettled buy and sell orders if the attribute is an exit order for all transactions.

6. (canceled)

7: A foreign exchange margin trading support system for downloading a platform from a server of an FX company via the Internet to an investor's terminal device for conducting foreign exchange margin trading, displaying a foreign exchange rate streamed from the FX company in a form of a chart, and automatically placing an entry order or an exit order at timing specified by the investor,
wherein the investor's terminal device comprises:
line setting means for drawing a straight line connecting a start point and an end point specified with a cursor on the screen in the form of the chart,
line information storage means for associating identification information with the line drawn by the line setting means, calculating respective time values from a straight line equation for the line, and storing the calculated time value for each piece of the identification information,
transaction attribute selection means for displaying an attribute list representing types of the transactions when a predetermined area of the line is manipulated with the cursor, displaying a selected attribute on the area when any attribute is selected from the list, and storing the attribute in association with the identification information stored in the line information storage means,
transaction attribute output means for comparing the value stored in the line information storage means to the foreign exchange rate and reading and outputting, from the transaction attribute selection means, the attribute associated with the identification information of the line for which the value has been calculated when the value is within a predetermined range from the foreign exchange rate,
order information output means for outputting order information in which a predetermined parameter stored in parameter storage means is added to the attribute when the attribute outputted from the transaction attribute output means is detected, and
order placing means for executing the order information outputted from the order information output means, displaying a conducted transaction result on the screen, and storing the conducted transaction result in storage means.

8: The foreign exchange margin trading support system as recited in claim 7, wherein the transaction attribute selection means is operable to display, at a side of the area in which the attribute is displayed, an ON/OFF button for allowing selection of activation or inactivation of the attribute with operation of the cursor.

9: The foreign exchange margin trading support system as recited in claim 7, wherein the attribute list displayed by the transaction attribute selection means includes a buy order, a sell order, an order change, an exit order for a buy order, an exit order for a sell order, and an exit order for all transactions.

10: The foreign exchange margin trading support system as recited in claim 7, wherein the line can freely be moved or deleted with operation of the cursor, and
the transaction attribute selection means is operable to move a display position of the list and a display area of the attribute when the line is moved and to delete the list and the attribute when the line is deleted.

11: The foreign exchange margin trading support system as recited in claim 9, wherein the order placing means is operable to
conducted a transaction in accordance with the parameter included in the order information if the attribute of the order information is a buy order or a sell order,
conducted a transaction to settle an oldest unsettled buy order if the attribute is an exit order for a buy order, conducted a transaction to settle an oldest unsettled sell order if the attribute is an exit order for a sell order, and conducted a transaction to settle all unsettled buy and sell orders if the attribute is an exit order for all transactions.
